(19) United States
(12) Patent Application Publication
(10) Pub. No.: US 2008/0266332 A1
(43) Pub. Date: Oct. 30, 2008

(54) DISPLAY CORRECTION CIRCUIT OF ORGAN EL PANEL

(75) Inventors: Yasuo Inoue, Tokyo (JP); Masahiro Ito, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/108,741

(22) Filed: Apr. 24, 2008

(30) Foreign Application Priority Data
Apr. 26, 2007 (JP) 2007-116326

(51) Int. Cl. G09G 5/10; G09G 3/30

(52) U.S. Cl. 345/690; 345/76; 345/77

(57) ABSTRACT

A display correction circuit of an organic EL panel for correcting, for display purposes, a video signal supplied to an organic EL panel, the display correction circuit includes: a linear gamma circuit supplied with a video signal which has been subjected to a predetermined gamma correction, the linear gamma circuit adapted to cancel the gamma correction of the video signal to convert the signal into a video signal having a linear gamma characteristic and adapted to output the resultant signal; a correction circuit supplied with the video signal from the linear gamma circuit; and a panel gamma circuit supplied with the video signal from the correction circuit, the panel gamma circuit adapted to convert the video signal into a video signal having a gamma characteristic associated with the gamma characteristic of the organic EL panel and adapted to output the resultant signal.

### CROSS REFERENCES TO RELATED APPLICATIONS

The present invention contains subject matter related to Japanese Patent Application JP 2007-116326 filed with the Japan Patent Office on Apr. 26, 2007, the entire contents of which being incorporated herein by reference.

### BACKGROUND OF THE INVENTION

1. Field of the Invention

The present invention relates to a display correction circuit of an organic EL panel.

2. Description of the Related Art

Some panel-shaped display devices use an organic EL (OLED) panel. The organic EL panel has a plurality of organic EL elements arranged in a matrix form. Each of the organic EL elements is associated with one pixel (one of the red, green and blue pixels).

FIG. 5 illustrates the principle of a drive circuit for an organic EL element. A drive transistor (TFT) Q and organic EL element D are connected in series to a power source +VDD. The transistor Q is supplied with a video signal voltage V.

Therefore, the signal voltage V is converted into a signal current I by the transistor Q. The signal current I flows through the organic EL element D. This causes the organic EL element D to emit light L at the brightness (emission intensity) associated with the magnitude of the signal current I. As a result, the pixel is displayed at the brightness associated with the signal voltage V.

As described above, a display device using an organic EL panel can be reduced in thickness because it is self-luminous and therefore demands no backlights as does the liquid crystal display. Further, the light emission thereof is achieved by excitons in the organic semiconductor. As a result, the display device has high energy conversion efficiency, making it possible to reduce the voltage demanded for light emission down to several volts or so.

Further, the organic EL panel offers high response speed and wide color reproduction range. Still further, the panel is immune to magnetic field interference unlike the cathode ray tube (picture tube). It should be noted that the organic EL is also called the organic LED or OLED.

The following document is available as an existing art document: Japanese Patent Laid-Open No. 2005-300929, hereinafter referred to as Patent Document 1.

### SUMMARY OF THE INVENTION

Incidentally, the video signal must be corrected in various manners to achieve high image quality in the display device using an organic EL panel. Patent Document 1 describes a display device adapted to compensate for brightness deterioration caused, for example, by a change over time. To accomplish this, the organic EL panel of the display device has current detection means so that the potential difference is corrected according to the detected current.

In an organic EL panel, however, there is a case where various corrections are demanded. Among such corrections are correcting the change of white balance or color temperature over time, protecting the panel against excessive current, and preventing or minimizing phosphor burn-in. To that end, it is necessary to detect the driving condition of the organic EL panel with more ease and accuracy for purposes of corrections and control.

There is a need for the present invention to detect, in a display device using an organic EL panel, the driving condition of the organic EL panel with more ease and accuracy for purposes of corrections and control so as to maintain excellent display quality.

The present embodiment is a display correction circuit operable to correct, for display purposes, a video signal supplied to an organic EL panel.

The display correction circuit includes a linear gamma circuit, correction circuit and panel gamma circuit. The linear gamma circuit is supplied with a video signal which has been subjected to a predetermined gamma correction. The same circuit cancels the gamma correction of the video signal to convert the signal into a video signal having a linear gamma characteristic and output the resultant signal. The correction circuit is supplied with the video signal from the linear gamma circuit. The panel gamma circuit is supplied with the video signal from the correction circuit. The same circuit converts the video signal into a video signal having a gamma characteristic associated with the gamma characteristic of the organic EL panel and outputs the resultant signal. The correction circuit includes a detection section and correction section. The detection section detects the driving condition or history of the organic EL panel based on the video signal supplied to the correction circuit. The correction section corrects the video signal supplied to the organic EL panel using the detection output of the detection section.

The display correction circuit of the present embodiment converts the input signal into a video signal having a linear input/output characteristic. The same circuit detects the driving condition of the organic EL panel based on the information of the converted signal having a linear input/output characteristic. The same circuit uses the detection result to correct the output video signal. Then, the same circuit corrects the video signal to match the gamma characteristic of the organic EL panel. As a result, the organic EL elements of the panel emit the light L at the brightness (emission intensity) proportional to the magnitude of a drive current I (the optical output is linear to the drive current).

Therefore, the value of the information of the converted signal having a linear input/output characteristic is associated with the optical output of the organic EL panel, namely, the driving condition of the organic EL element.

The present embodiment allows for easy detection of the driving condition or history of an organic EL panel based on information of a converted signal having a linear input/output characteristic. This makes it possible to correct the video signal properly with a relatively small-scale circuit configuration based on the detection result, thus maintaining high image quality on the organic EL panel.

### BRIEF DESCRIPTION OF THE DRAWINGS

FIG. 1 is a system diagram illustrating an embodiment of the present invention;

FIGS. 2A to 2E, 3, and 4 are characteristic diagrams for describing the operation of a circuit shown in FIG. 1;

FIG. 5 is a connection diagram for describing the characteristic of an organic EL element; and

FIGS. 6A to 6E are characteristic diagrams for describing the operation of the organic EL element shown in FIG. 5.

### DETAILED DESCRIPTION OF THE PREFERRED EMBODIMENT

### [1] Example of the Overall Configuration

When a display device using an organic EL panel reproduces a high quality image, the video signal must be corrected in various manners. Among corrections demanded are correction of the variation between organic EL panels, correction of uneven light emission across the panel (for brightness uniformity), correction of local uneven light emission, correction of the change of white balance and color temperature over time, protection of the panel against excessive current and prevention or minimization of phosphor burn-in.

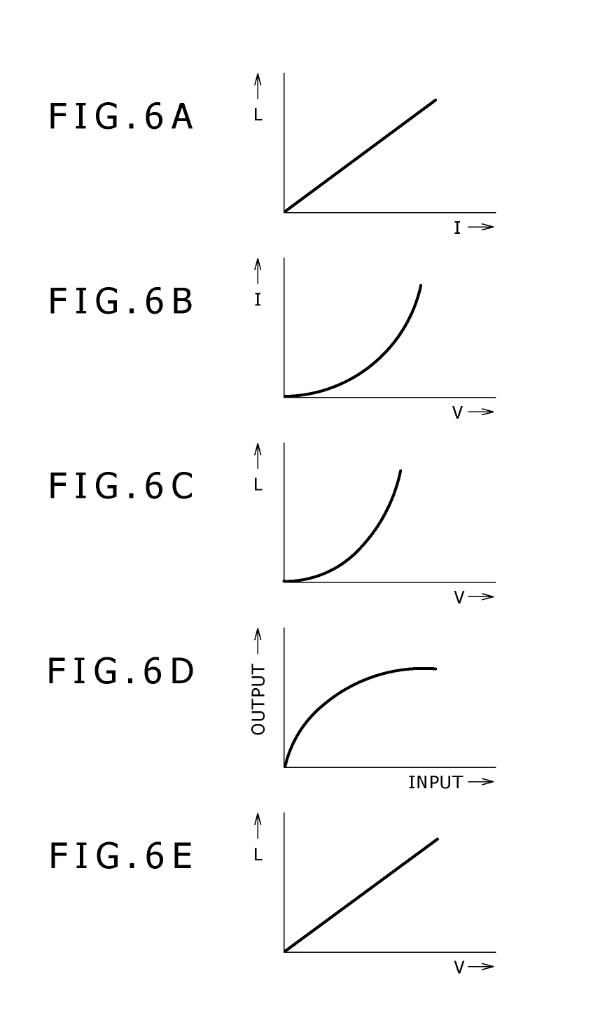

In the meantime, the signal current I and brightness (emission intensity) L of the organic EL element D are linearly proportional to each other as illustrated in FIG. 6A. However, if the signal voltage V is supplied to the transistor Q, the relation between the signal voltage V and signal current I changes to an exponential characteristic as illustrated in FIG. 6B because of the characteristic of the transistor Q. As a result, the relation between the signal voltage V and brightness L of the organic EL element D has an exponential characteristic as illustrated in FIG. 6C.

As illustrated in FIG. 6D, therefore, the display device using an organic EL panel has a correction circuit having an exponential input/output characteristic which is complementary to the characteristic shown in FIG. 6C. Using this correction circuit, the video signal must be corrected so that the signal voltage V (before correction) and brightness L are linearly proportional to each other as illustrated in FIG. 6E. That is, an inverse gamma correction is demanded.

This inverse gamma correction is performed differently depending on the variation of the characteristic of the transistor Q. Therefore, it is preferable to set a correction value appropriate for each organic EL panel. Further, an inverse gamma correction may be performed adaptively for the transistor Q of each pixel according to the display area or signal level. Still further, such a correction according to the display area or signal level may be performed by a separate functional block.

On the other hand, a video signal used, for example, in television broadcasting is gamma-corrected before being fed to the cathode ray tube so that the signal voltage and brightness are linearly proportional to each other. However, the characteristic of the gamma correction for the cathode ray tube differs from that of the gamma correction demanded for the organic EL elements (FIG. 6D). For a display device using an organic EL panel, therefore, the difference in characteristic must be considered between the gamma correction for the cathode ray tube and that for the organic EL elements.

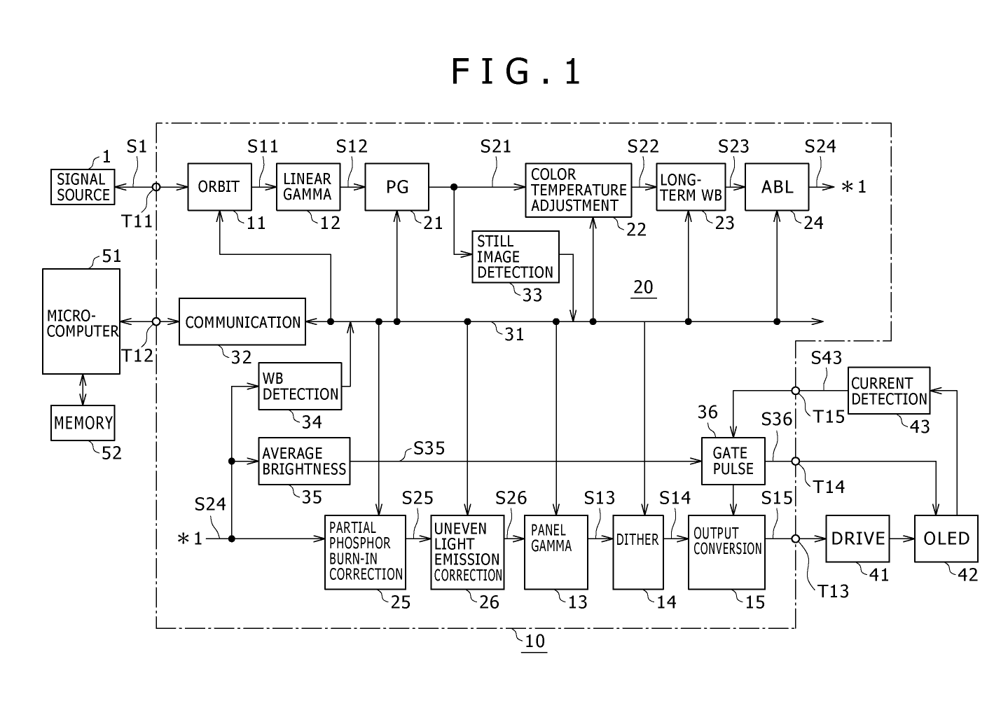

FIG. 1 illustrates an example of a display correction circuit handling the above various corrections and an example of use thereof. That is, an area 10 enclosed by a dashed line in FIG. 1 illustrates the display correction circuit. This circuit is incorporated in an LSI or implemented on a single IC chip by using FPGA. The IC (display correction circuit) 10 has terminal pins T11 to T15 for external connections.

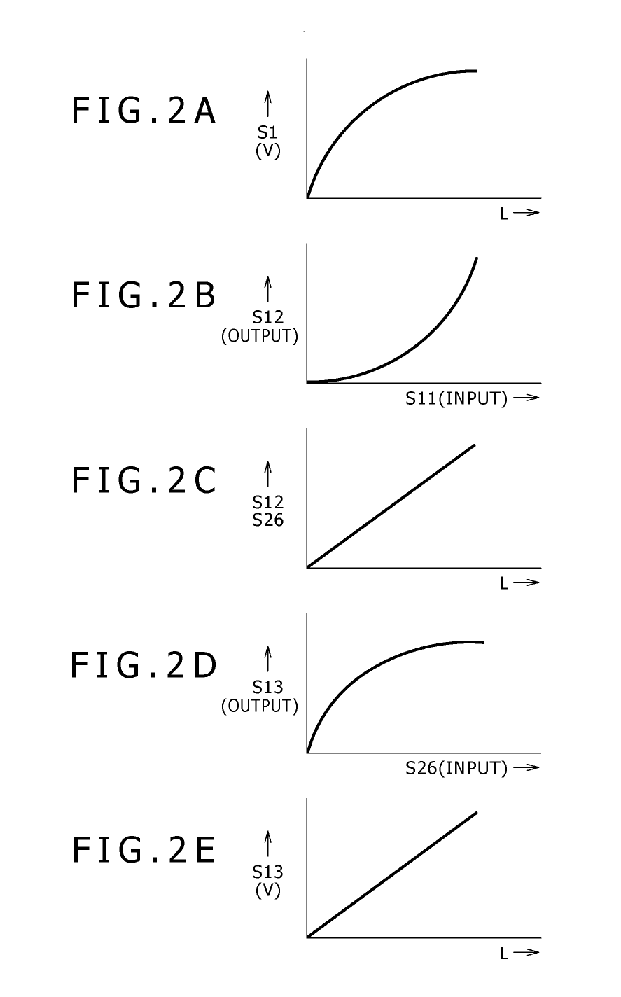

Reference numeral 1 denotes a signal source such as tuner circuit or DVD player. A video signal (three-primary-color signal made up of red, green and blue) S1 is supplied from the signal source 1. The video signal S1 is a digital signal and has a standard comparable to the video signal used in television broadcasting. As illustrated in FIG. 2A, therefore, the video signal S1 undergoes the gamma correction for the cathode ray tube so that the characteristic thereof can be approximated by the following equation:

L=k1·V̂(1/γ1)
L: Brightness of the subject
V: Signal voltage of the signal S1
γ1: Gamma value which is generally about 2.2
K1: Constant
̂: Arithmetic symbol denoting power

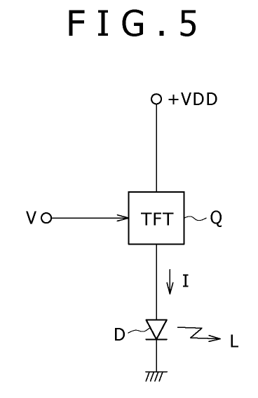

Further, reference numeral 42 denotes an organic EL panel for image display. This organic EL panel includes transistors, one for each organic EL element, as described in relation to FIG. 5, and has a light emission characteristic which can be approximated by the following equation as illustrated in FIG. 6C:

L=k2·V̂γ2
L: Brightness of the organic EL element
V: Input signal voltage
γ2: Gamma value
k2: Constant
   It should be noted that the aspect ratio of the panel 42 is, for example, 16:9.

Reference numeral 51 denotes a control microcomputer which controls the corrections performed in the display correction circuit 10 automatically or at the instruction of external equipment.

The video signal S1 from the signal source 1 is supplied to an orbit circuit 11 via the terminal pin T11 of the IC 10. The orbit circuit 11 periodically shifts the entire image on the organic EL panel 42 in vertical and horizontal directions slowly enough to be unnoticed by the viewer so as to make any phosphor burn-in of the panel 42 inconspicuous. That is, by doing so, any phosphor burn-in resulting from the display of a still image or standard 4:3 image over a long period of time will be inconspicuous because the outline thereof is blurred. Thus, a video signal S11 reduced in phosphor burn-in is extracted from the orbit circuit 11.

Next, the video signal S11 is supplied to the linear gamma circuit 12 which corrects the same signal S11 into a video signal S12. The linear gamma circuit 12 cancels the gamma characteristic of the video signal S11. As a result, the video signal S12 has an input/output characteristic as illustrated in FIG. 2B which is complementary to the gamma characteristic (FIG. 2A) of the video signal S11. The input/output characteristic is expressed by the following equation:

S12=k3·S11̂γ1
k3: Constant

Therefore, the linear gamma circuit 12 outputs the video signal S12. The video signal S12 has a characteristic in which the signal voltage V changes linearly to the subject brightness L as illustrated in FIG. 2C. It should be noted that the video signal S12 is 14 bits per sample.

The video signal S12 is supplied to a correction circuit 20. Although described in detail later in Section [2], the correction circuit 20 includes circuits 21 to 26 and performs the various corrections under the control of the microcomputer 51. The correction circuit 20A outputs a corrected video signal S26. It should be noted that the video signal S26 changes linearly to the brightness L as illustrated in FIG. 2C.

The video signal S26 is supplied to a panel gamma circuit 13 which corrects the same signal S26 into a video signal S13. The panel gamma circuit 13 cancels the gamma characteristic of the organic EL panel 42 by adding a predetermined gamma characteristic to the video signal S13. As illustrated in FIG. 2D, therefore, the panel gamma circuit 13 has an input/output characteristic which is complementary to the characteristic in FIG. 6C (characteristic same as that in FIG. 6D). The input/output characteristic is expressed by the following equation:

S13=k4·S26̂(1/γ2)
k4: Constant
   Therefore, the panel gamma circuit 13 outputs the video signal S13. The video signal S13 has a gamma characteristic in which the brightness L of the organic EL panel 42 changes linearly to a signal voltage V13 as illustrated in FIG. 2E. At this time, the video signal S13 is 12 bits per sample.

Further, the video signal S13 is supplied to a dither circuit 14 which corrects the same signal S13 into a video signal S14. The video signal S14 is a dithered signal which is 10 bits per sample. The video signal S14 is supplied to an output conversion circuit 15. The output conversion circuit 15 converts the three-primary-color signal into a video signal S15, for example, in RSDS (registered trademark) format. The video signal S15 is extracted from the terminal pin T13.

The video signal S15 extracted from the terminal pin T13 is supplied to a drive circuit 41 which converts the same signal S15 into analog form. Then, the resultant signal is supplied to the organic EL panel 42. As a result, the video signal S1 from the signal source 1 is displayed on the organic EL panel 42 as a color image.

### [2] Configuration Example of the Correction Circuit 20

The correction circuit 20 includes the circuits 21 to 26. The circuits 21 to 26 handle the corrections as described below.

That is, the video signal S12 from the linear gamma circuit 12 is supplied to the pattern generator circuit 21. The pattern generator circuit 21 outputs the supplied video signal S12 in an as-is manner as a video signal S21 during normal viewing. During adjustment or inspection of the organic EL display device using the display correction circuit 10 and organic EL panel 42, however, the same circuit 21 forms a video signal for various kinds of adjustments or tests which will be displayed as a test pattern or color bar and outputs this signal rather than the video signal S12 as the video signal S21.

The video signal S21 from the pattern generator circuit 21 is supplied to the color temperature adjustment circuit 22. The same circuit 22 converts the same signal S21 into a video signal S22 having a color temperature set by the viewer. The same signal S22 is supplied to the long-term white balance correction circuit 23. The same circuit 23 corrects the change of white balance over time which occurs after an extended period of use of the organic EL panel 42, and then outputs a video signal S23 with corrected white balance.

Further, the video signal S23 with corrected white balance is supplied to the ABL circuit 24. The same circuit 24 corrects the video signal S23 into a video signal S24 having a limited peak brightness. The video signal S24 is supplied to the partial phosphor burn-in correction circuit 25. The same circuit 25 detects partial phosphor burn-in based on the signal level and time, and then outputs a video signal S25 which has been corrected for phosphor burn-in.

The video signal S25 is supplied to the correction circuit 26 for uneven light emission (circuit to provide brightness uniformity) across the screen of the organic EL panel 42. The same circuit 26 corrects the video signal S25 to generate a video signal S26 with uniform brightness. Therefore, the video signal 26 from the correction circuit 20 has been not only corrected for uneven light emission by the uneven light emission correction circuit 26 but also subjected to various corrections by the circuits 21 to 25. The same signal S26 is supplied to the panel gamma circuit 13 as described above.

### [3] Detailed Description of Control Performed by the Correction Circuit 20

To perform the above corrections properly, the display correction circuit 10 has a control bus line 31. The same line 31 is connected to the terminal pin T12 via a communication circuit 32. The control microcomputer 51 is connected to the terminal pin T12. A non-volatile memory 52, adapted to store various pieces of data and history records, is connected to the microcomputer 51.

The video signal S21 (video signal for broadcasting or other use under normal conditions) from the pattern generator circuit 21 is supplied to a still image detection circuit 33. The same circuit 33 detects whether the image displayed according to the video signal S21 is a still image. A detection signal S32 thereof is supplied to the microcomputer 51 via the communication circuit 32.

As a result, the microcomputer 51 forms a predetermined control signal based on the detection signal S32. Further, the microcomputer 51 supplies the control signal to the orbit circuit 11 via the communication circuit 32. If the image displayed according to the video signal S21 is a still image, the orbit circuit 11 controls the display position thereof, thus reducing or making inconspicuous any phosphor burn-in of the organic EL panel 42. It should be noted that this process can be achieved by shifting the portion of the waveform of the video signal S11 to be displayed as an image relative to vertical and horizontal synchronizing signals.

Further, the microcomputer 51 supplies a control signal to the pattern generator circuit 21 via the communication circuit 32 to switch the operation of the same circuit 21, for example, between the following three different modes:
output the video signal S12 from the linear gamma circuit 12 in an as-is manner
form and output a video signal to be displayed as a test pattern or color bar
form and output a video signal having a given level to provide a uniform brightness across the screen It should be noted that this switching is accomplished by the viewer or manufacturer's personnel in charge of inspection or adjustment issuing an instruction to the microcomputer 51 via the main microcomputer (not shown).

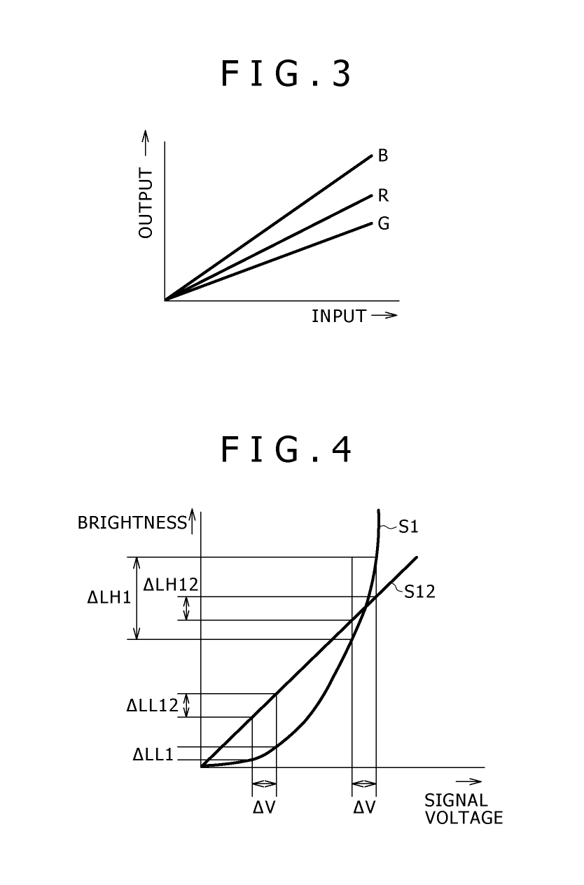

When the viewer or manufacturer's personnel in charge of inspection or adjustment issues an instruction to the microcomputer 51 to adjust and set the color temperature via the main microcomputer, the microcomputer 51 sends this instruction to the color temperature adjustment circuit 22 via the communication circuit 32 so that the color temperature is adjusted and set to provide the intended characteristic. It should be noted that the adjustment and setting of the color temperature is accomplished, for example, by adjusting and setting the slope of the input/output characteristic in FIG. 3 for each of the three primary colors RGB.

Further, the video signal S24 from the ABL circuit 24 is supplied to a white balance detection circuit 34 to correct the change of white balance over time. A detection signal S34 is extracted from the video signal (three-primary-color signal) S24 for each color signal. Each of the detection signals S34 indicates the voltage level of one of the color signals. The detection signals S34 are supplied to the microcomputer 51 via the communication circuit 32.

In this case, each of the detection signals S34 indicates the level of one of the color signals. Therefore, each of these signals indicates the brightness of one of the colors of the organic EL panel 42. Therefore, the microcomputer 51 accumulates the detection signals S34 for the three colors to calculate the accumulated amounts of light emission (brightness×time) the three colors.

The larger the accumulated amount of light emission, the lower the brightness of the organic EL panel 42. That is, the accumulated amount of light emission is also associated with the extent of deterioration of the brightness of each of the three colors of the organic EL panel 42. A table is stored in advance in a memory 52. The table indicates the extent of brightness deterioration for each color for the accumulated amount of light emission. The microcomputer 51 looks up this table based on the calculated accumulated amount of light emission to find a correction value for each color. The microcomputer 51 supplies these correction values to the long-term white balance correction circuit 23 via the communication circuit 32. As a result, the same circuit 23 changes the slope of the input/output characteristic in FIG. 3 to correct the change of white balance over time.

As described above, the input signal having a gamma characteristic is converted into a video signal having a linear input/output characteristic. Using the information of the converted signal having a linear input/output characteristic, the accumulated amount of light emission is found by simple addition. This allows detection of information of the driving condition of the organic EL panel 42. Based on the detection result, the table stored in the memory 52 is looked up so that the slope of the input/output characteristic is changed by a simple calculation to correct the output video signal.

Then, the video signal is corrected to match the gamma characteristic of the organic EL panel 42. As a result, the element of the organic EL panel 42 emits the light L at the brightness (emission intensity) proportional to the magnitude of the drive current I (the optical output is linear to the drive current). Therefore, the value of the information of the converted signal having a linear input/output characteristic is associated with the optical output of the element of the organic EL panel 42, namely, the driving condition of the element.

As described above, the information of the converted signal having a linear input/output characteristic provides an easy means of detecting the driving condition of the organic EL panel. The driving condition allows for detection of the driving history thereof. As a result, the video signal can be corrected properly with a relatively small-scale circuit configuration based on the detection result, thus maintaining high image quality on the organic EL panel.

Further, the video signal S24 from the ABL circuit 24 is supplied to an average brightness detection circuit 35. The same circuit 35 detects, for example, the average brightness per frame based on the ratio of the voltages of the color signals contained in the video signal S24. A detection signal S35 thereof is supplied to a gate pulse circuit 36 as a control signal. The same circuit 36 controls the duty ratio of the light emission period of the organic EL panel 42, namely, the ratio of the light emission period of the organic EL panel 42 per frame.

Thus, the gate pulse circuit 36 outputs a control signal S36. The control signal S36 controls the duty ratio of the light emission period of the organic EL panel 42 in a frame succeeding the frame for which the duty ratio thereof has been calculated. The same signal S36 is supplied to the organic EL panel 42 via the terminal pin T14 as a duty ratio control signal for that light emission period, thus protecting the same panel 42.

Further, the magnitude of the signal current I flowing through the organic EL panel 42 is measured by a current detection circuit 43. A detection signal S43 thereof is supplied to the gate pulse circuit 36 via the terminal pin T15. As a result of the detection of the signal current I flowing therethrough, the control signal S36 is controlled. In the event of a sharp change of the magnitude of the signal current I flowing through the organic EL panel 42 before the frame succeeding the frame in which the signal current is measured, the current supplied to the organic EL panel 42 is restricted, thus protecting the same panel 42 against the excessive signal current I.

Also in this case, the average brightness can be detected by finding the total sum of the image data values per frame using the information of the signal having a linear input/output characteristic converted between the linear and panel gamma circuits 12 and 13. The average brightness is associated with the total current supplied to the organic EL panel 42. As a result, simple signal processing using four arithmetic operations provides control to protect the organic EL panel 42.

Further, the uneven light emission correction circuit 26 corrects uneven light emission across the screen of the organic EL panel 42. This correction is conducted during adjustment or inspection. That is, the pattern generator 21 outputs the video signal S12 having a uniform level. Therefore, the panel 42 emits light at a uniform brightness unless there is uneven light emission.

Therefore, the entire surface of the organic EL panel 42 is captured with a video camcorder or other imaging device to detect any uneven light emission of the panel 42. It should be noted that this detection is conducted, for example, for all emission colors, namely, red, blue and green. The detection result thereof is supplied to the microcomputer 51. The microcomputer 51 refers to the table based on the level of the video signal S25 and the coordinate position (scan position) in the organic EL panel 42 to calculate a correction value. This correction value is supplied to the uneven light emission correction circuit 26 via the communication circuit 32 to correct uneven light emission.

As described above, the correction circuit 20 handles various corrections, including color temperature adjustment, correction of the change of white balance over time, correction of the organic EL panel 42 for phosphor burn-in and uneven light emission and limitation of the maximum brightness. The resultant image is displayed on the organic EL panel 42.

### [4] Conclusion

According to the display correction circuit 10, the correction circuit 20 performs various corrections for the organic EL panel 42, thus providing a high quality image. In all corrections performed by the correction circuit 20, the video signal S1 having a gamma characteristic for the cathode ray tube is converted into the video signal S12 having a linear gamma characteristic as illustrated in FIG. 2E by the linear gamma circuit 12. All corrections and level detection for the corrections are performed on the video signal S12, thus providing a reliable means of performing the corrections with a simple circuit configuration.

That is, the input video signal S1 has a gamma characteristic as illustrated in FIG. 4. We assume that the video signal S1 (or video signal S11) is subjected to a correction. In this case, even if a voltage change ΔV at a low voltage level is equal to the voltage change ΔV at a high voltage level, a brightness change ΔLL1 relative to the voltage change ΔV at a low voltage level differs from a brightness change ΔLH1 relative to the voltage change ΔV at a high voltage level.

That is, correction sensitivities (ΔLL1/ΔV, ΔLH1/ΔV) differ from each other according to the voltage level of the video signal S1. Therefore, if various corrections are performed as mentioned earlier, the control range (ΔV) must be changed according to the level of the video signal S1 for each correction. This leads to a more complicated configuration of the correction circuit 10, possibly resulting in less-than-optimal corrections.

However, the display correction circuit 10 converts the input video signal S1 into the video signal S12 having a linear characteristic as illustrated in FIG. 2C using the linear gamma circuit 12. Thus, the video signal S12 (or signals S21 to S25), rather than the video signal S1, is subjected to the corrections. This ensures that the brightness change ΔLL1 relative to the voltage change ΔV at a low voltage level of the video signal S12 is equal to the brightness change ΔLH1 relative to the voltage change ΔV at a high voltage level thereof.

That is, the correction sensitivities (ΔLL12/ΔV, ΔLH12/ΔV) are equal to each other, irrespective of the voltage level of the video signal S12. This makes it possible for the correction circuit 20 to correct the video signal S12 properly during the corrections, thus simplifying a circuit configuration.

Moreover, the video signal S12 (signals S21 to S25), converted by the linear gamma circuit 12 to have a linear characteristic as illustrated in FIG. 2C, is subjected to a gamma correction for the organic EL panel 42 by the panel gamma circuit 13. This ensures a proper gamma correction for the organic EL panel having a different gamma characteristic, achieving a high quality image on the screen.

Further, the video signal used for various detections by the detection circuits 33 to 35 has a linear characteristic. This provides the same video signal detection sensitivity irrespective of the signal level, ensuring high detection accuracy and providing a high quality image.

### [5] Others

If the same gamma characteristic as the video signal S1 is imparted to the test video signal from the pattern generator 21 in the above description, the pattern generator 21 may be provided in the previous stage of the linear gamma circuit 12.

It should be understood by those skilled in the art that various modifications, combinations, sub-combinations and alterations may occur depending on design requirements and other factors insofar as they are within the scope of the appended claims or the equivalents thereof.

### [List of the Acronyms]

### ABL: Automatic Brightness Limiter

### EL: Electro Luminescence

### FPGA: Field Programmable Gate Array

### IC: Integrated Circuit

### LED: Light Emitting Diode

### LSI: Large Scale Integration

### OLED: Organic Light Emitting Diode

RSDS: Reduced Swing Differential Signaling (registered trademark)
TFT: Thin Film Transistor

What is claimed is:

1. A display correction circuit of an organic EL panel for correcting, for display purposes, a video signal supplied to an organic EL panel, the display correction circuit comprising:
a linear gamma circuit supplied with a video signal which has been subjected to a predetermined gamma correction, the linear gamma circuit adapted to cancel the gamma correction of the video signal to convert the signal into a video signal having a linear gamma characteristic and adapted to output the resultant signal;
a correction circuit supplied with the video signal from the linear gamma circuit; and
a panel gamma circuit supplied with the video signal from the correction circuit, the panel gamma circuit adapted to convert the video signal into a video signal having a gamma characteristic associated with the gamma characteristic of the organic EL panel and adapted to output the resultant signal, wherein
the correction circuit includes
a detection section adapted to detect the driving condition or history of the organic EL panel based on the video signal supplied to the correction circuit, and
a correction section adapted to correct the video signal supplied to the organic EL panel using the detection output of the detection section.

2. The display correction circuit of claim 1, wherein
the detection section detects an amount of light emission of the organic EL panel based on the level of the video signal, and
the correction section controls the level of a video signal from the correction circuit according to the detection output of the amount of light emission.

3. The display correction circuit of claim 1, wherein
the detection section detects an average brightness per frame of the organic EL panel based on the level of the video signal, and
the correction section controls, according to the detection output of the average brightness, the level of a video signal output from the correction circuit in a frame succeeding the frame in which the average brightness has been detected.

4. The display correction circuit of claim 1, wherein
the detection section detects the accumulated amount of light emission of the organic EL panel based on the level of the video signal, and
the correction section corrects the white balance of a video signal output from the correction circuit according to the detection output of the amount of light emission.
